(19) United States
(12) Patent Application Publication
(10) Pub. No.: US 2026/0307293 A1
(43) Pub. Date: Oct. 8, 2026

(54) RAPID-SET CONSTRUCTION MATERIAL FOR 3D PRINTING OF SUSTAINABLE INFRASTRUCTURE

(71) Applicant: Oregon State University, Corvallis, OR (US)

(72) Inventors: Devin Roach, Corvallis, OR (US); Nicolas A. Gonsalves, Corvallis, OR (US); Pavan Akula, Corvallis, OR (US)

(73) Assignee: Oregon State University, Corvallis, OR (US)

(21) Appl. No.: 19/637,966

(22) Filed: Apr. 2, 2026

Related U.S. Application Data
(60) Provisional application No. 63/783,156, filed on Apr. 3, 2025.

(51) Int. Cl. B28B 1/00; B28B 23/02; B29C 64/118; B29K 33/00; B29K 105/12; B29L 31/10; B33Y 10/00; B33Y 70/10; C04B 14/02; C04B 14/06; C04B 14/10; C04B 16/06; C04B 26/20; C04B 111/00

(52) U.S. Cl. CPC B28B 1/001; B28B 23/02; B29C 64/118; B33Y 10/00; B33Y 70/10; C04B 14/022; C04B 14/06; C04B 14/104; C04B 14/106; C04B 16/0625; C04B 16/0633; C04B 16/0683; C04B 16/0691; C04B 26/20; B29K 2033/26; B29K 2105/12; B29L 2031/10; C04B 2111/00181

(57) ABSTRACT

Disclosed herein is a concrete composition comprising a reinforcement material comprising a clay material, a sand material, a biochar material, an organic fiber material and a binder material. The binder material comprises a polymer. A disclosed ratio of binder material wt % to reinforcement material wt % ranges between 11:69 to 15:69. A method is also disclosed, wherein the method may include, for example, beginning an extrusion of the disclosed concrete mixture to create an extrudate, initiating a polymerization front of the extrudate, and beginning direct writing of the extrudate.

### CLAIM OF PRIORITY

This application claims priority of US Provisional Application 63/783,156, filed Apr. 3, 2025, titled “Rapid-set Construction Material for 3D Printing of Sustainable Infrastructure,” which is incorporated by reference in its entirety.

### BACKGROUND

The exponential growth of the human population has led to a global housing crisis. In recent years additive manufacturing (AM), also known as 3D printing, has become widely used for on-demand infrastructure construction to solve this problem. Although 3D printing shows immense promise for reducing construction time and improving structural design freedom, the materials used still have several issues. The most common material, cement-based concrete, takes up to 48 hours to fully set, which prevents construction of more than 7 layers per day. Additionally, the printing process is paused to install support for printing over gaps such as door frames and windows. Apart from physical constraints, cement production is not sustainable, making up roughly 8% of global CO₂ emissions. While contemporary 3D printed concrete allows for the autonomous fabrication of complex internal and external geometries, it introduces additional limitations. For instance, cement-based concrete requires approximately 10 hours to fully set.

Additionally, cement-based concrete suffers from poor compressive strength immediately after extrusion. For example, an exemplary compressive strength would be roughly 1.8 kPa, which results in structural buckling after printing subsequent layers. The number of layers that can be deposited before pausing printing and waiting for the concrete to set depends on the ratio of cement to aggregate, dimensions of each layer, and the footprint of the structure. One study found that for its given printing parameter it could print 19-28 layers before collapse which resulted in a 60 cm tall structure. This limitation is referred to as the material's buildability. Although reducing water content can improve buildability, this comes at the cost of increasing viscosity, making it difficult for current 3D printers to extrude the material. This limitation is known as extrudability. Consequently, while cement-based concrete is extrudable, it lacks sufficient buildability to allow for continuous layer deposition. Another challenge associated with 3D printing cement-based concrete is the need for support structures when printing over gaps, such as windows and doors. This requires pausing the print to place supports, such as wooden planks, before continuing the print. Together, these limitations highlight the need for modifications to both the infrastructure materials and the 3D printing process to achieve next-generation infrastructure which can meet the needs of the growing population.

### BRIEF DESCRIPTION OF DRAWINGS

Material described herein is illustrated by way of example and not by way of limitation in accompanying figures. For simplicity and clarity of illustration, elements illustrated in figures are not necessarily drawn to scale and exact locations. For example, dimensions of some elements can be exaggerated relative to other elements for clarity. Also, various physical features can be represented in their simplified “ideal” forms and geometries for clarity of discussion, but it is nevertheless to be understood that practical examples can only approximate illustrated ideals. For example, smooth surfaces and square intersections can be drawn in disregard of finite roughness, corner-rounding, and imperfect angular intersections characteristic of structures formed that may be present. Further, where considered appropriate, reference labels have been repeated among figures to indicate corresponding or analogous elements.

FIG. 1A illustrates a concrete printing apparatus for direct-write additive manufacturing (e.g., 3D printing) of structures that are to be employed as parts of buildings, or printing of entire buildings, in accordance with at least one embodiment.

FIG. 1B shows a schematic view of a frontal polymerization of a polymer-based concrete extrudate, in accordance with at least one embodiment.

FIG. 2 illustrates a plot of the effect of binder content on the velocity of polymerization front of the concrete extrudate having a composition according to at least one embodiment.

FIG. 3 illustrates a plot showing the effect of ammonium persulfate initiator content on the velocity of the polymerization front of the concrete extrudate having a composition according to at least one embodiment.

FIG. 4 illustrates a plot showing the effect of dry content on the velocity of the polymerization front of the concrete extrudate having a composition according to at least one embodiment.

FIG. 5 illustrates a plot showing a relationship between compressive strength of the concrete mixture as a function of time after extrusion of a concrete extrudate having a composition in accordance with at least one embodiment.

FIG. 6A illustrates a plot showing a relationship between compressive strength of the disclosed concrete mixture and binder content in wt % for a concrete extrudate having a composition in accordance with at least one embodiment.

FIG. 6B illustrates a plot showing a relationship between binder content and density of the disclosed concrete mixture for a concrete extrudate having a composition according to at least one embodiment.

FIG. 7 illustrates a plot showing a relationship between compressive strength and dry content of the disclosed concrete mixture for a concrete extrudate having a composition according to at least one embodiment.

FIG. 8 shows a system comprising concrete printing apparatus shown in FIG. 1A for direct-write additive manufacturing of building structures, in accordance with at least one embodiment.

FIG. 9A illustrates the printing of a multilayer extrudate by the system shown in FIG. 8, implementing the 3D DIW concrete printing process, in accordance with at least one embodiment.

FIG. 9A bis illustrates a profile view of a wall formed by the 3D DIW concrete printing process illustrated in FIG. 9A, in accordance with at least one embodiment.

FIG. 9B illustrates a 3D profile view of a box structure produced by the 3D DIW concrete printing process in accordance with at least one embodiment.

FIG. 9B bis illustrates a 3D top-down view of the box structure shown in FIG. 9B, looking into an interior cavity of the box structure, in accordance with at least one embodiment.

FIG. 9C illustrates a 3D profile view of a pyramid structure produced by the 3D DIW concrete printing process in accordance with at least one embodiment.

FIG. 9C bis illustrates a 3D top-down view of the pyramid structure shown in FIG. 9C, looking into an interior cavity of the pyramid structure, in accordance with at least one embodiment.

FIG. 9D illustrates a three-dimensional spiral structure produced by the 3D DIW printing process, in accordance with at least one embodiment.

FIG. 10 illustrates molecular structures of crosslinker, initiator, and monomer of the binder mixture in accordance with at least one embodiment.

FIG. 11 illustrates a flowchart for an exemplary method for direct writing of the concrete mixture having a composition according to at least one embodiment.

### DETAILED DESCRIPTION

Described herein is a renewable clay-based composite construction material that provides structural properties comparable to concrete but which cures directly after printing. Thermally initiated frontal polymerization of acrylamide-based binder enables setting during extrusion, allowing layers to be printed consecutively. While cement comprises up to 20% of traditional concrete, the disclosed material contains 70-80 wt % organic materials, in accordance with at least some implementations. The printed material reaches buildable strengths of 2 MPa immediately after printing and surpasses 17 MPa, the strength required of residential structural concrete, in under 10 days. The methods described herein show great promise for the on-demand fabrication of sustainable infrastructure, especially for housing in rural or underserved communities.

To address the challenge of buildability, some manufacturers have added up to three times by weight of cement, generating self-supporting architecture. However, cement-based concrete is weaker with less aggregate, and has significant environmental impacts. Cement production is responsible for approximately 8% of global CO₂ emissions. To limit the use of high loading of cement, others add accelerant during printing. While this has shown promise for rapid curing of infrastructure, it requires very careful mixing and continued monitoring of the process. Furthermore, the accelerants used in the process typically use calcium chloride which poisons aquatic ecosystems. In an approach to find alternative aggregates, the use of clay, sand, biochar, and natural fibers has been investigated. These alternate materials have been introduced in place of traditional aggregates. While this approach reduces the environmental footprint of concrete, it does not address the core issue of cement's high carbon emissions.

An alternative solution is the employment of thermoplastics, which are common 3D materials. For example, wood fiber-reinforced polylactic acid (PLA) has been used to 3D-print a one-story house. However, wood fiber-reinforced PLA presents several drawbacks. Namely, PLA is a thermoplastic polymer, meaning it can be repeatedly heated and remolded. Although thermoplastics are convenient for 3D printing, they tend to lack strong mechanical properties and corrosion resistance relative to traditional construction materials and require a heated extrusion head to melt the plastic prior to extrusion. For instance, PLA's glass transition temperature can be as low as 55° C., which could pose significant challenges in hotter climates. Additionally, 3D-printed PLA is biodegradable and thus not entirely waterproof, creating issues in wetter environments.

Although the addition of wood fibers improves sustainability, it does little to resolve these limitations. Other thermoplastics commonly used in 3D printing, such as Acrylonitrile Butadiene Styrene (ABS), polyethylene terephthalate (PETG) and polycarbonate (PC), also exhibit similar shortcomings. As a result, the field of 3D printing is shifting away from thermoplastics toward the use of thermoset polymers. Thermoset polymers offer greater mechanical properties and performance with less variance across different temperatures and environments. Despite their advantages, thermosets have been less widely used in infrastructure materials due to the difficulties of achieving large, complex geometries caused by material curing cycles.

A promising new technique, called frontal polymerization (FP), is being explored to address this issue. This technique, specifically Radical-Induced Cationic Frontal Polymerization (RICFP), has shown potential for curing during the extrusion process. RICFP relies on chemical components including a monomer, a crosslinker, and an initiator: a monomer, a crosslinker, and an initiator. The monomer polymerizes in the presence of a free radical, while the crosslinker forms covalent bonds between polymer strands, creating a high strength mesh structure that is the binder component of the disclosed concrete mixture, in accordance with at least some implementations.

In at least one implementation, the ammonium persulfate initiator degrades under an applied, controllable external trigger, generally at a certain temperatures, releasing free radicals to start the polymerization. Thermally initiated frontal polymerization may be combined with clay aggregates to increase compressive strength of the cured concrete exudate. Through parameter optimization, this allows the extruder nozzle and the polymerization front to move at the substantially the same velocity, enabling continuous printing without support, thereby reducing material consumption and print time. However, challenges can arise when incorporating organic or mineral-based aggregates, which have surface properties that differ significantly from most polymers, potentially hindering effective bonding and reducing mechanical strength.

To address these challenges, in at least one implementation, a concrete mixture comprising an acrylamide-based polymer binder (described below) formed by RICFP, a clay aggregate, sand, hemp fiber, and biochar reinforcements is used. In at least one implementation, the concrete composition creates a rapid-setting, sustainable alternative concrete material for additive manufacturing (e.g., 3D printing) of infrastructure such as buildings, houses, etc.

In at least one embodiment, the binder composition comprises an acrylamide compound as the monomer, N, N'-methylenebisacrylamide as the crosslinker, and ammonium persulfate as the thermal initiator. After extrusion and exposure to a thermal trigger, the concrete frontally polymerizes following the extruded print path. Immediately after curing, the material exhibits a compressive strength exceeding 17 MPa, meeting the structural requirements for residential buildings. In at least one embodiment, the concrete demonstrates a compressive strength increase of over 3 MPa immediately after polymerization, with full curing achieved in less than 14 days. This 14-day curing time is less than half the curing time of traditional cement-based concrete. In at least one embodiment, the inclusion of clay and plant-based fiber (e.g., hemp fiber) or synthetic fiber reinforcements further enhances the compressive strength and reduces the environmental impact of the material. (up to 45 MPa).

The monomer mixture utilizes the exothermic nature of the RICFP polymerization reaction, allowing a self-propagating polymerization front to occur in the concrete mixture. In at least one embodiment, the RICFP method enables a rapid curing of extruded concrete due to self-generated heat from the exothermic polymerization, which enables propagation of the polymerization front along the extrudate. In some embodiments, the curing is rapid as relative amounts of monomer, cross-linker and initiator (henceforth the ratio of monomer: crosslinker: initiator may be expressed as M:C:I) may be adjusted to control the speed of propagation of the polymerization front, and by consequence, the speed of extrusion of the concrete mixture may be influenced by the M:C:I ratio. In at least one embodiment, crosslinker content may range between 1 and 2 wt %. In at least one example, the binder mixture comprises 11.53 wt % acrylamide as monomer, 1.34 wt % N, N′-methylene bisacrylamide cross-linker, and 3.89 wt % ammonium persulfate as thermal initiator, and 14.17 wt % water as solvent. These are wt % relative to the total concrete composition. Here, the M:C:I ratio (expressed as a wt % ratio) is 8.6:1:2.9.

In some embodiments, the curing is virtually instantaneous as relative amounts of polymer binder, monomer and cross-linker, and reinforcement materials such as clay, sand, hemp, and biochar (henceforth the ratio of binder to reinforcement material may be expressed as B:R) may be optimized to control the speed of propagation of the polymerization front, and by consequence, the speed of extrusion of the concrete mixture may be controlled by the B:R ratio, expressed in terms of wt %, ranging from 1:7 to 2:7. In at least one embodiment, the binder is a cross-linked acrylamide-based polymer, having a polyamide backbone and cross-linking groups comprising primary amide groups.

In at least one embodiment, the polymerization front may be initiated by starting the extrusion of the concrete mixture and applying external heat to the front of the extrudate. The external heat source may be in the form of a flame, for example, or a hot object such as a red-hot bar or rod. The external heat supplies the energy of activation to start the reaction. Once initiated, the exothermic reaction mixture begins to polymerize and generate heat, enabling self-propagation of the polymerization front along the freshly extruded concrete. In at least one embodiment, the direction of propagation is in the opposite direction of the extrusion. For example, the polymerization front propagates toward the source of the concrete mixture, which may be a print head comprising a pressurized tank or vessel that employs a plunger, an auger mechanism, or a pump for forcing the concrete mixture through an extrusion nozzle.

Thus, in at least one embodiment, the mixture is extruded as a semiliquid mixture and extruded at a speed that matches the speed of propagation of the polymerization front. In at least one embodiment, the extrudate front develops a compressive strength of 3 MPa immediately after polymerization, enabling continuous printing of the concrete without support, thereby reducing material consumption and print time. If the extrusion speed is too slow, the polymerization front may enter the vessel, potentially causing premature curing of the mixture within the extrusion vessel before it is extruded. If the extrusion speed is too fast, then the polymerization front may not keep up with the print head extruder nozzle, and the extrudate may lose heat, slowing down the rate of polymerization and reducing curing rate.

Thus, the speed of extrusion and therefore printing speed may be increased by use of the b:r ratios disclosed herein. Extruded concrete may develop a compressive strength far exceeding 17 MPa after full curing occurring in less than 14 days, which is less than half the curing time of traditional cement-based concrete. It is noted that 17 MPa compressive strength is the minimum structural requirement for concrete used in residential buildings. These properties of the disclosed concrete mixture may decrease the time needed to produce 3D printed structures such as shelters, houses, warehouses, etc.

In at least one embodiment, mineral and/or organic aggregates are added to the disclosed concrete mixture. Such aggregates may include biochar, clay particles (e.g., kaolinite clay) and hemp fibers. The action of such aggregates increases compressive strength of the disclosed concrete mixture once cured.

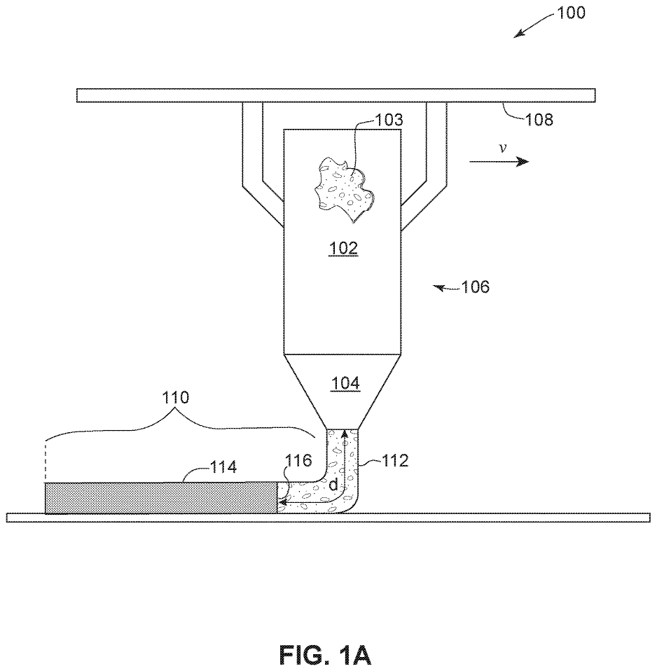

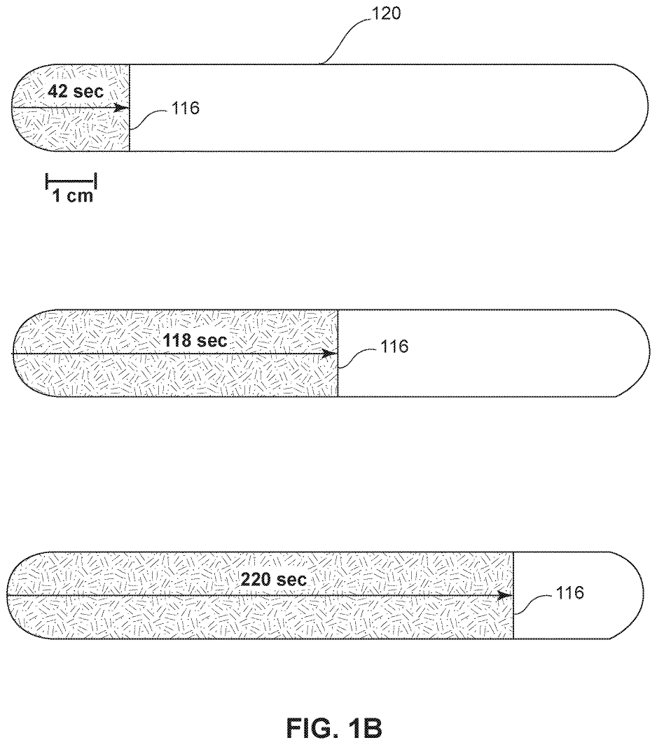

FIG. 1A illustrates a concrete DIW 3D printing apparatus 100 for direct-write additive manufacturing (e.g., 3D printing) of structures that are to be employed as parts of buildings, or printing of entire buildings. In at least one embodiment, the concrete printing apparatus 100 comprises a reservoir 102 that includes an extrusion nozzle 104. The reservoir contains a liquid concrete mixture 103. Pressure applied by various means, such as a plunger mechanism, an auger system or a pumping mechanism, forces the concrete mixture through extrusion nozzle 104. The reservoir and nozzle 104 may be unitary, in that together they form a print head 106 that moves as a single unit.

A gantry system 108 may be employed to translate the print head 106 in two or more directions, enabling formation of an elongated extrudate 110. Extrudate 110 includes a short unpolymerized zone 112 that first exits nozzle 104, and an extrudate 114 comprising an elongated polymerized zone that precedes unpolymerized zone 112. The boundary between the two zones is the polymerization front 116. The distance between polymerization front 116 and nozzle 104 may be determined by the b:r ratio of concrete mixture 103 and the extrusion speed. In at least one embodiment, polymerization front 116 moves at the same velocity v of print head 106. Thus, the distance d between nozzle 104 and polymerization front 116, which may be measured as the length of unpolymerized zone 112, remains substantially constant.

In some embodiments, a leuco dye may be included in concrete mixture 103, which changes color upon polymerization of the binder, changes color at a specific temperature. For example, a leuco dye may be chosen to change color to pink from black at 35° C. If the leuco dye is present, extrudate 114 may have a different color than unpolymerized zone 112, having a sharp boundary at polymerization front 116. The use of leuco dye may enable visualization of polymerization front 116 for monitoring of a 3D concrete print process. In some embodiments, the velocity of polymerization front 116 may vary between 2 and 10 cm/min. Various components of concrete mixture 103 can have significant effects on the velocity of polymerization front 116, as will be described in the following paragraphs.

FIG. 1B shows a schematic view of a frontal polymerization of a polymer-based concrete extrudate 120, similar to extrudate 110. In the example shown, polymerization front 116 is propagating at a rate of approximately 3 cm/min. The shaded zone of the extrudate indicates the extent of the polymerized zone with a sharp polymerization front clearly seen. The color is due to the presence of a leuco dye mixed into the concrete mixture. The scale bar in FIG. 1B represents a distance of 1 cm.

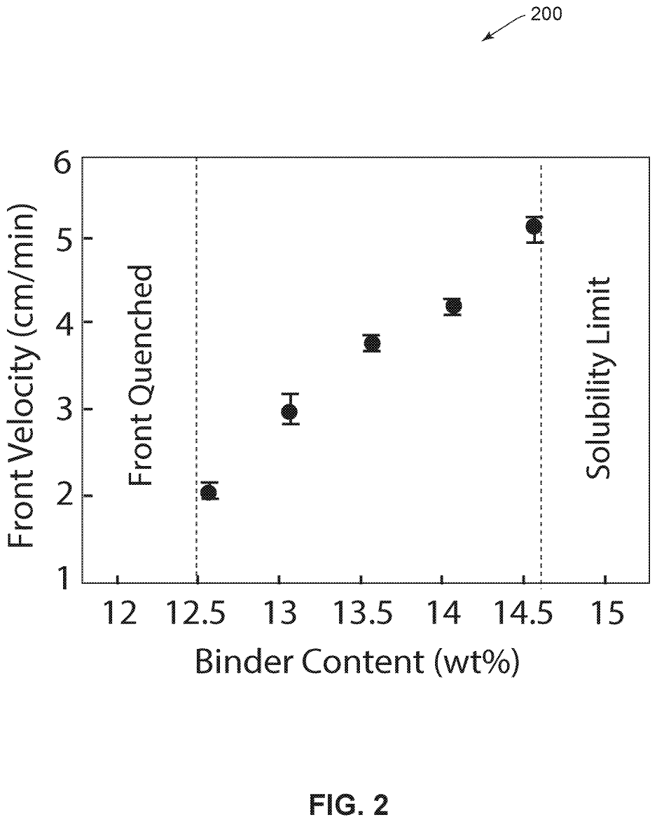

FIG. 2 illustrates a plot 200 of the effect of binder content on the velocity of polymerization front of the concrete extrudate having a composition according to at least one embodiment. Here, binder content is expressed as a weight percentage (wt %). Binder content is expressed as a wt % based on the weight of an aqueous binder solution containing the monomer and cross linker components of the unreacted binder that is added to the concrete mixture comprising the mineral and organic components sans binder. Here, binder content ranges between 12.6 wt % and 14.5 wt %. A change of approximately 2 wt % in binder content changes the velocity of the polymerization front by 57%, from 3.2 cm/min to 5.0 cm/min. Below a binder content of 12.6 wt % the extrudate exhibited quenching, whereby the polymerization front self-extinguishes. Beyond a binder content of 14.5 wt %, the binder components may not completely dissolve in the concrete mixture. For example, the crosslinker may not dissolve without dissolved monomer being present in the solution. In at least one embodiment, the binder mixture comprises 15 wt % or less of monomer. Larger monomer content in the binder solution causes faster polymerization front velocities.

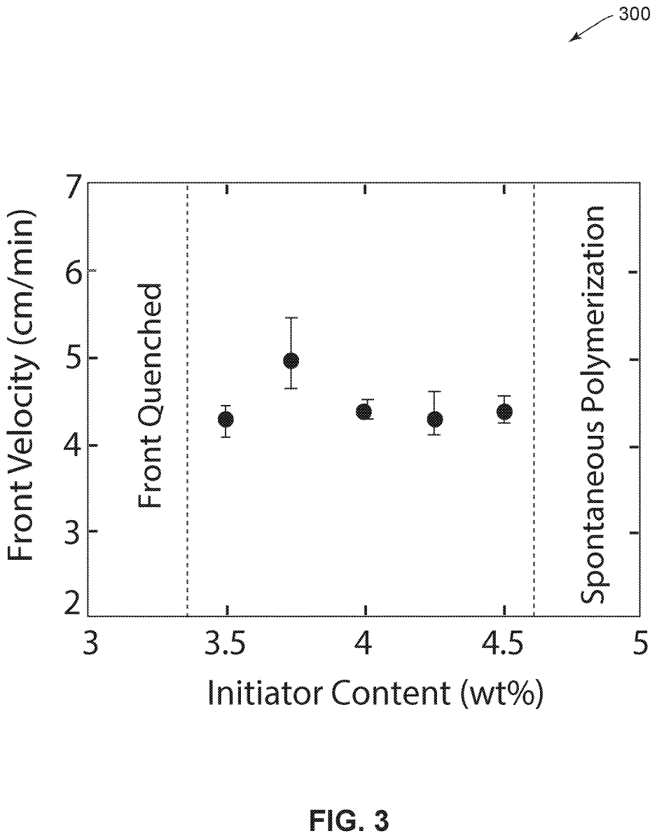

FIG. 3 illustrates a plot 300 showing the effect of ammonium persulfate initiator content on the velocity of the polymerization front of the concrete extrudate having a composition according to at least one embodiment. Plot 300 shows an initiator content ranging between 3 and 5 wt % relative to the total concrete mixture. The velocity of the polymerization front is approximately constant over this range of initiator content. While frontal velocity was relatively unaffected, the initiator content did affect the performance of the frontal polymerization. Initiator content below 3 wt % resulted in quenching of the front due to a lack of sufficient persulfate anion concentrations that supply free radicals to sustain frontal polymerization. The persulfate anion decomposes slowly at room temperature. At initiator concentrations of 4.5 wt % and higher, the binder may spontaneously polymerize due to slow decomposition of a small fraction of the persulfate anions at room temperature (e.g., 22.5° C.). In at least one embodiment, initiator content ranges from 2 to 14 wt %.

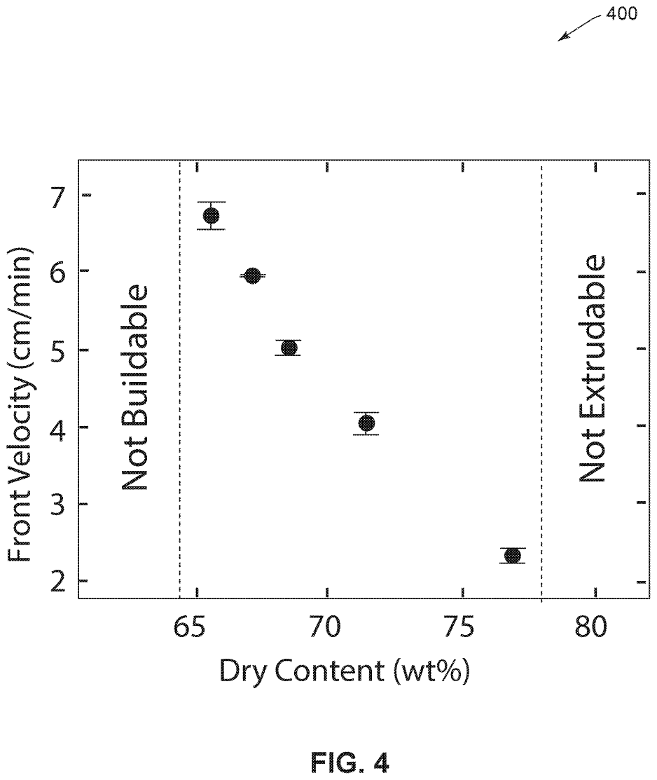

FIG. 4 illustrates a plot 400 showing the effect of dry content on the velocity of the polymerization front of the concrete extrudate having a composition according to at least one embodiment. Here, the ratio of dry content weight percentages of the disclosed concrete mixture had the most significant impact on polymerization velocity. The dry content includes clay and sand particles and organic materials including biochar and plant-based or synthetic fibers. In at least one embodiment, clays may include particles of kaolinite clay, bentonite clay, fire clays, ball clays, stoneware clays such as lateritic clay. In at least one embodiment, plant-based fibers may include jute fiber, hemp fiber, coir (e.g., coconut) fiber, bamboo fiber, or sisal fiber. In at least one embodiment, synthetic fibers may include polyamide (e.g., Nylon) fibers, polyester fiber, polypropylene fiber, polycarbonate fiber, polyethylene fiber, glass fiber or alkali-resistant cellulose. Dry content ranging from 65 to 77 wt % produced frontal velocities ranging from 2.32 cm/min to 6.7 cm/min, respectively. The higher wt % of dry contents resulted in lower front velocities. Below 65 wt % dry content, the concrete became too liquidous and could not hold its shape after extrusion. Above 77 wt % dry content, the concrete became too viscous, preventing effective extrusion.

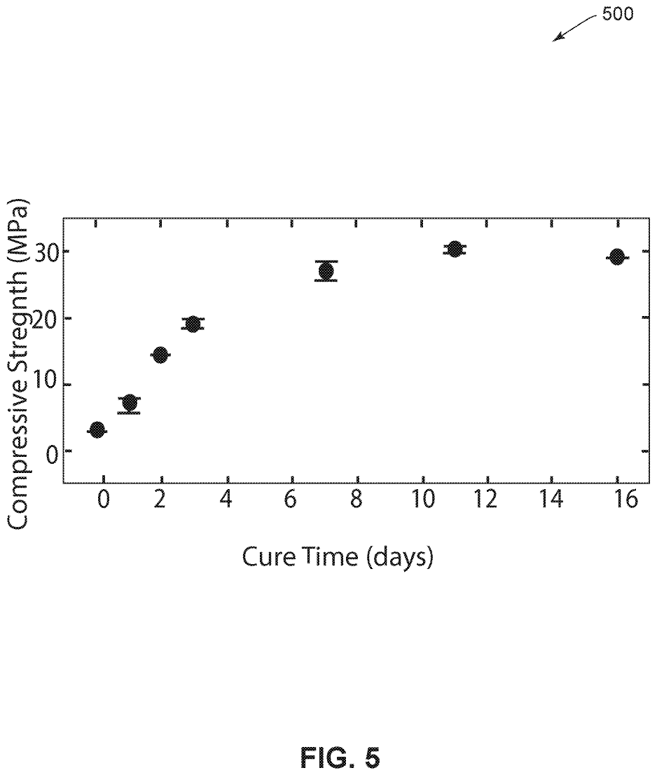

FIG. 5 illustrates a plot 500 showing a relationship between compressive strength of the concrete mixture as a function of time after extrusion of a concrete extrudate having a composition in accordance with at least one embodiment. Compressive strength is a significant factor in determining if a material is suitable for structures built for human occupation. Many state construction regulations in the United States require that residential infrastructures made from concrete have a minimum compressive strength between 17 and 24 MPa. Compression testing may be done in accordance with ASTM C39 to prove the viability of the material. According to ASTM standard C39, concrete achieves this compressive strength (17 to 24 MPa) after 28 days to be considered structural.

Plot 500 shows that the disclosed concrete mixture reaches over 3 MPa immediately after frontal polymerization is initiated and increases to almost 15 MPa after 1 day. The material plateaus at 12 days showing that it cures roughly 2.5 times faster than conventional concrete (cement based).

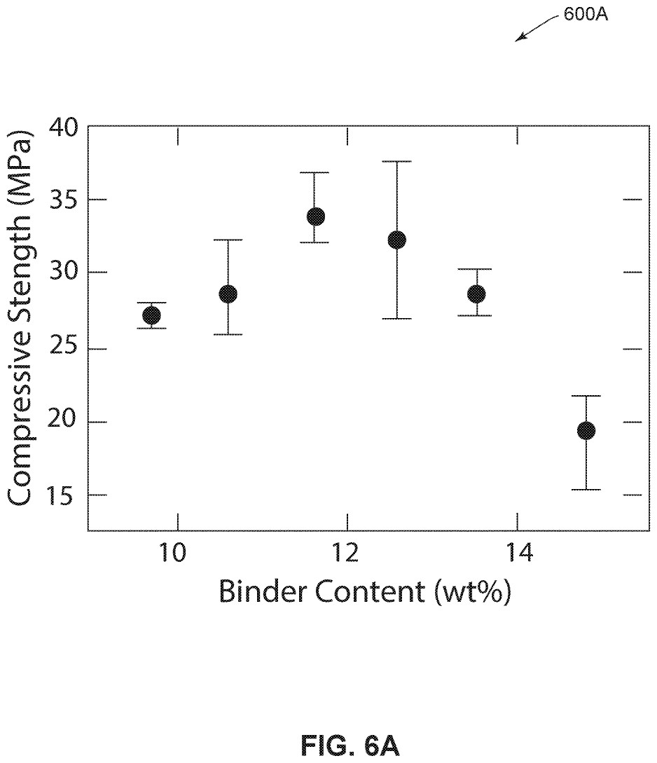

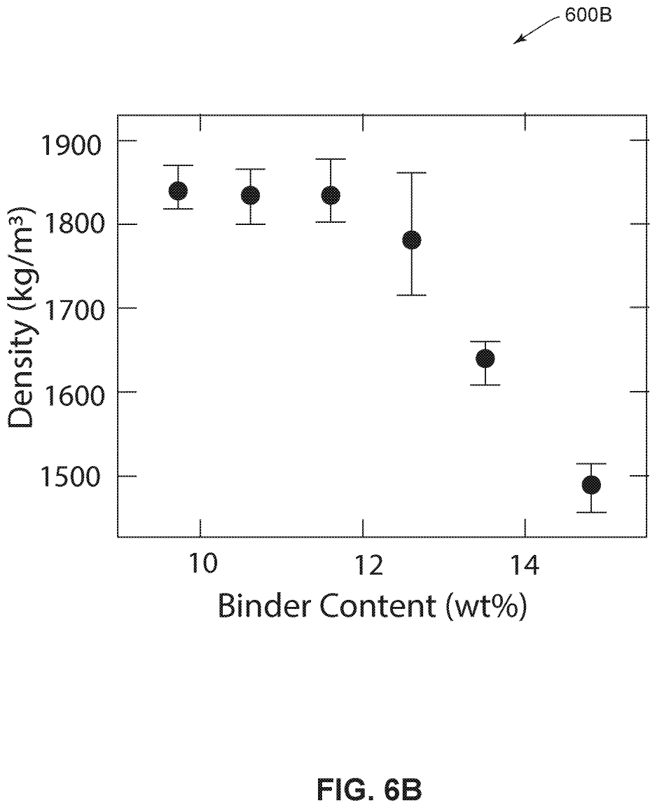

FIG. 6A illustrates a plot 600A showing a relationship between compressive strength of the disclosed concrete mixture and binder content in wt % for a concrete extrudate having a composition in accordance with at least one embodiment. As seen from plot 600A, the binder content has a significant impact on both density and compressive strength of the mixture. Plot 600A shows a peaked relationship between the compressive strength as function of binder content. At low concentrations of binder (e.g., less than 10 wt %), adherence of the polymer to hemp fiber and clay particles may be insufficient to prevent early fracture. At higher concentrations (e.g., greater than 12 wt %), the binder is carrying a greater percentage of the load than the aggregates (e.g., clay particles and hemp fibers), weakening the compressive strength of the concrete due to the lower compressive strength of the polymer binder than that of the aggregates. Thus, higher compressive strength (e.g., above 27-28 MPa) is achieved at moderate levels of binder. The disclosed concrete mixture may obtain compressive strengths up to 40 MPa.

FIG. 6B illustrates a plot 600B showing a corollary relationship between binder content and density of the disclosed concrete mixture for a concrete extrudate having a composition according to at least one embodiment. Plot 600B shows that concentrations of binder between approximately 10 wt % and 12 wt %, the density is constant at its highest values between 1800 and 1900 kg/m³. Above 12 wt %, the density of the concrete mixture (after complete curing) falls off steadily to approximately 1500 kg/m³. The steady falloff of density above approximately 12 wt % of binder correlates well to the fall-off of compressive strength observed at binder concentrations above 12 wt % shown in plot 600A of FIG. 6A. At these higher concentrations (>12 wt %), the excess binder can cause voids during the polymerization reaction creating higher porosity, leading to early fracture.

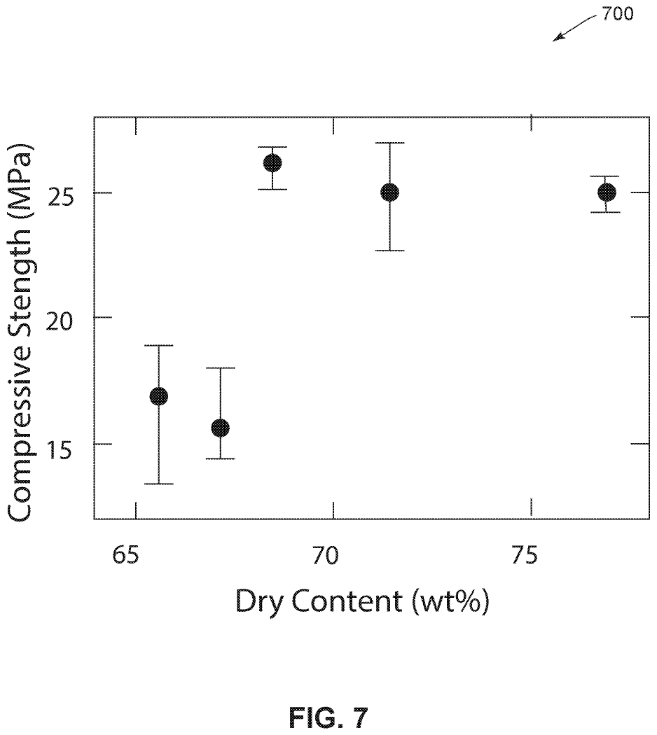

FIG. 7 illustrates a plot 700, showing a relationship between compressive strength and dry content of the disclosed concrete mixture for a concrete extrudate having a composition according to at least one embodiment. Concentrations of dry content below approximately 67 wt % tend to enable high concentrations of binder, which in the cured concrete negatively affect the compressive strength by increasing porosity and void density. At concentrations of dry content below 67 wt %, the compressive strength is well below 20 MPa, between 15 and 18 MPa. Compressive strength exhibits an abrupt rise to over 25 MPa at dry content concentrations above 67 wt %.

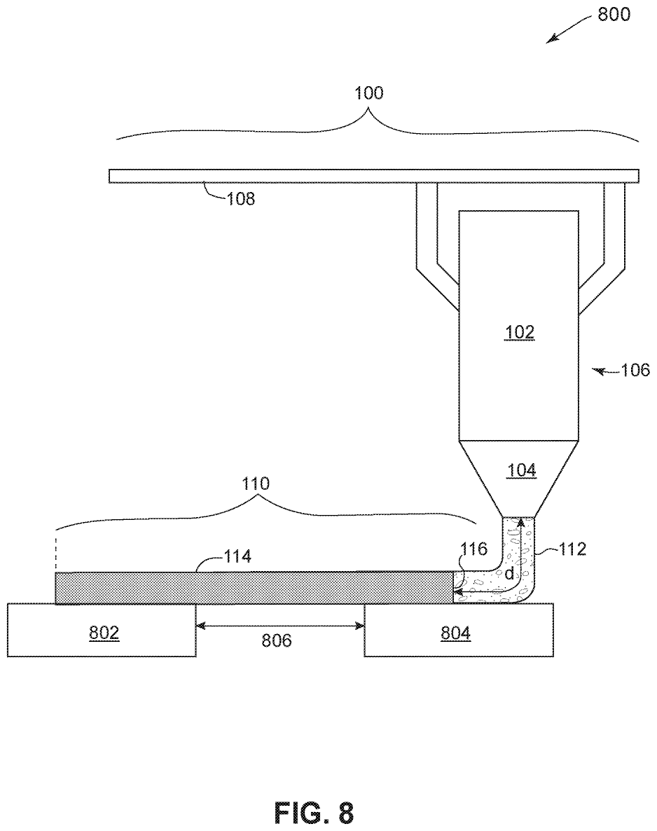

FIG. 8 shows a system 800 comprising concrete 3D DIW printing apparatus 100 for direct ink write (DIW) additive manufacturing of building structures. In at least one embodiment, the system 800 comprises supports 802 and 804 upon which an extrudate 110 is printed. In the illustrative embodiment, extrudate 110 maintains rigidity as it crosses over gap 806, which has a distance s of several centimeters. Rigidity of extrudate 110 and its ability to span gap 806 without sagging is due at least in part to the rapid development of compressive strength of 3 MPa or higher in less than one minute.

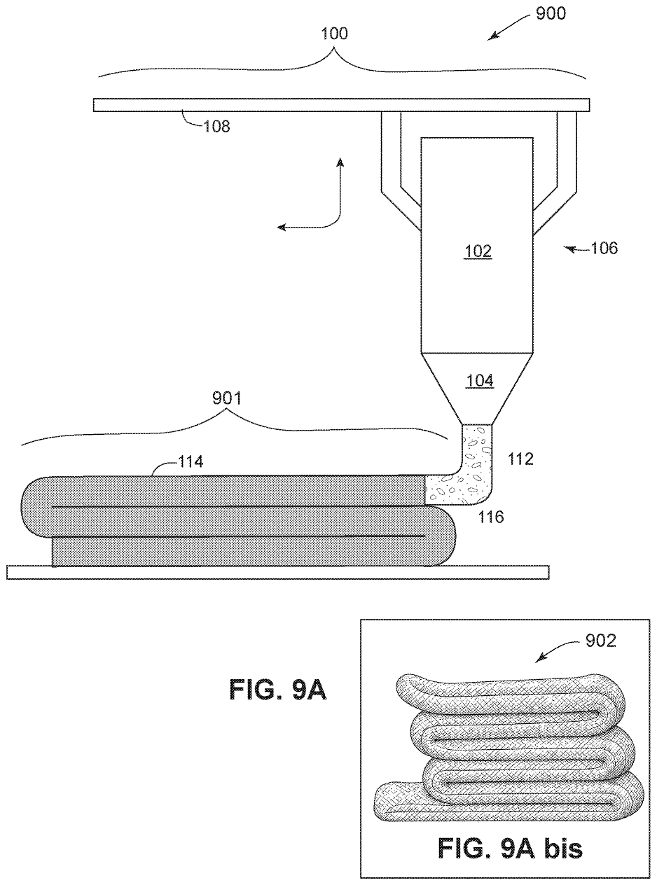

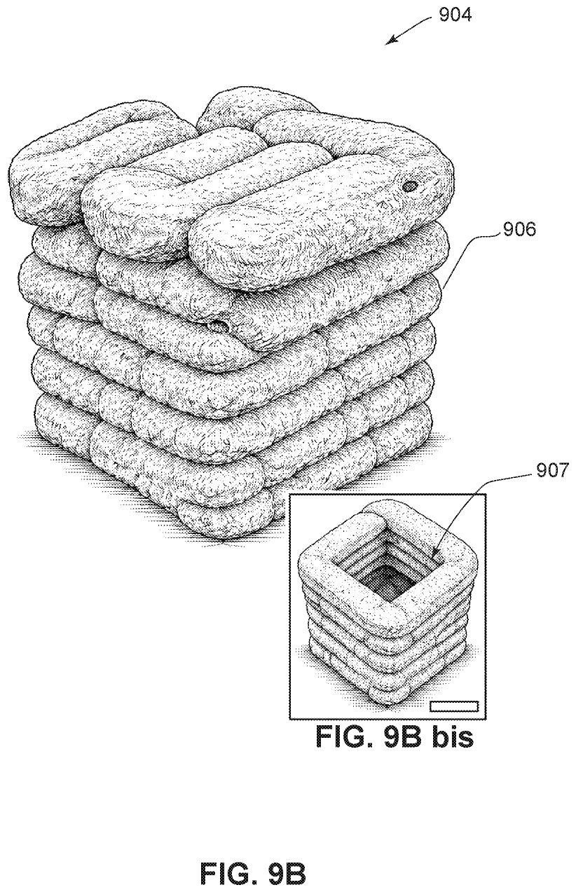

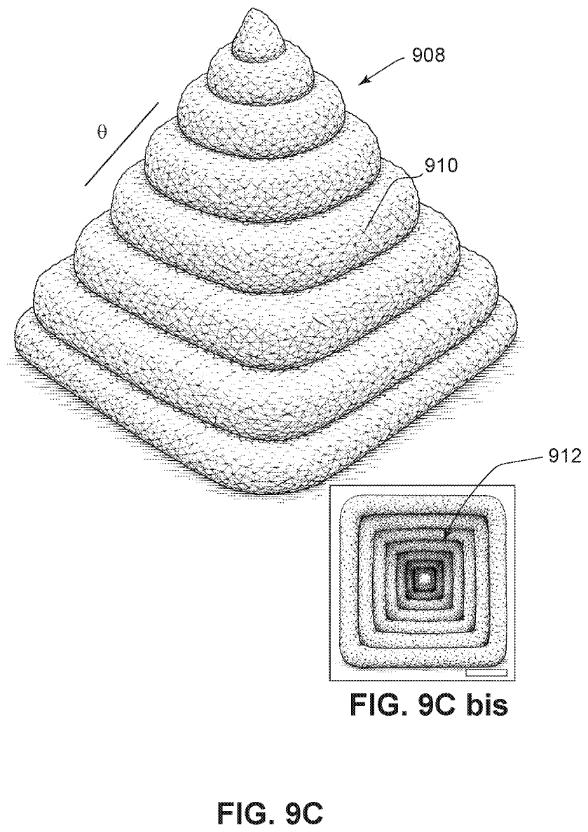

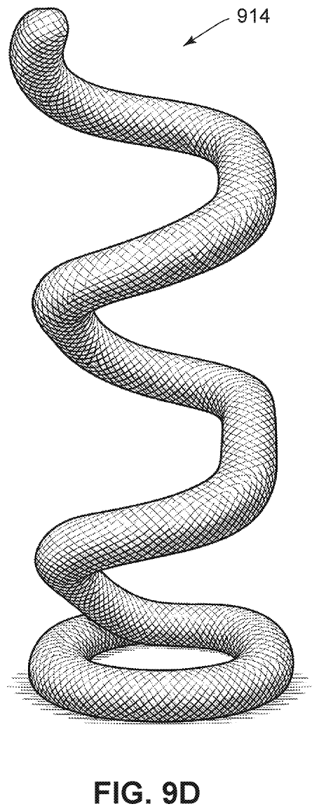

FIG. 9A illustrates a system 900 comprising a DIW 3D printing apparatus 100 for direct 3D printing of a wall 901 comprising a multilayer extrudate. In at least one embodiment, DIW 3D printing apparatus 900 is substantially similar to DIW 3D printing apparatus 100 shown in FIGS. 1A and 8. In the illustrative example, reservoir 102 is translated in two directions along gantry system 108. During translation of reservoir 102, extrudate 114 may be continuously extruded from extrusion nozzle 104, forming a wall 900 comprising multiple layers of extrudate 114 arranged in a stack. As noted above, extrudate 114 may develop a compressive strength of approximately 3 MPa or greater within a minute after leaving nozzle 104, enabling formation of wall 900 without showing signs of sag at any point. The compressive strength may linearly increase in a relatively rapid manner. For example, extrudate 114 may reach up to 20 MPa after three days, a rate that may be approximately 2.5 times faster than typical curing times for conventional concrete. In the illustrative example of FIG. 9A, wall 900 develops sufficient rigidity to support multiple layers of extrudate 114 as extrudate 114 exits from extrusion nozzle 104. For example, print speeds may be up to 10 cm/min of up to 10 cm may be enabled by the rapid cure speed. The overlay of extrudates 114 may be used to print structures. An example of a structure produced by the 3D DIW printing of overlying extrudate layers process described for FIG. 9A is a wall 902 shown in FIG. 9A bis.

FIGS. 9B and 9C show structures formed by printing multilayer extrudates, where the extrudates are produced by concrete printing apparatus 100. In FIG. 9B, a hollow box structure 904 formed by the 3D DIW process as described herein is shown. In the illustrative example, hollow box structure 904 comprises five layers of extrudate 906 where individual layers are formed into a two-dimensional square. The rapid rate of frontal polymerization resulting from the disclosed concrete composition enables rapid curing of the exudate extrudate as it flows out of the extrusion nozzle (e.g., extrusion nozzle 104). The lower extrudate layers may harden sufficiently to support subsequent deposition of extrudate overlayers, enabling rapid fabrication of structures such as hollow box structure 904. FIG. 9B bis shows a top 3D view of hollow box structure 904 looking into the interior cavity 907, showing that hollow box structure 904 can be constructed with high regularity and accuracy of dimensions.

In FIG. 9C, a pyramid structure 908 produced by the 3D DIW process described herein is shown. To form pyramid structure 908, the extrudate layers 910 may be systematically offset toward the center of the structure to produce a desired slope or taper angle (e.g., angle q), where the dimensions of succeeding layers are diminished to achieve the desired slope of the pyramid. FIG. 9C bis shows a top-down view of pyramid structure 908 looking into interior cavity 912.

In FIG. 9D, a three-dimensional spiral structure 912 produced by the 3D DIW process described herein is shown. In the illustrative embodiment, spiral structure 912 extends in the vertical direction of the figure (e.g., z) direction. The printing of spiral structure 912 produces contiguous self-supporting sloped extrudate segments. According to at least one embodiment, the binder composition and/or the extrusion rate may be adjusted to promote a rapid frontal polymerization rate to match the extrusion rate to the extent possible to more closely match the extrusion rate, which may help reduce or prevent sag and possible collapse. Such a method can allow the concrete mixture to harden as fast as it is extruded, enabling the formation of such self-supporting sloped segments of the spiral.

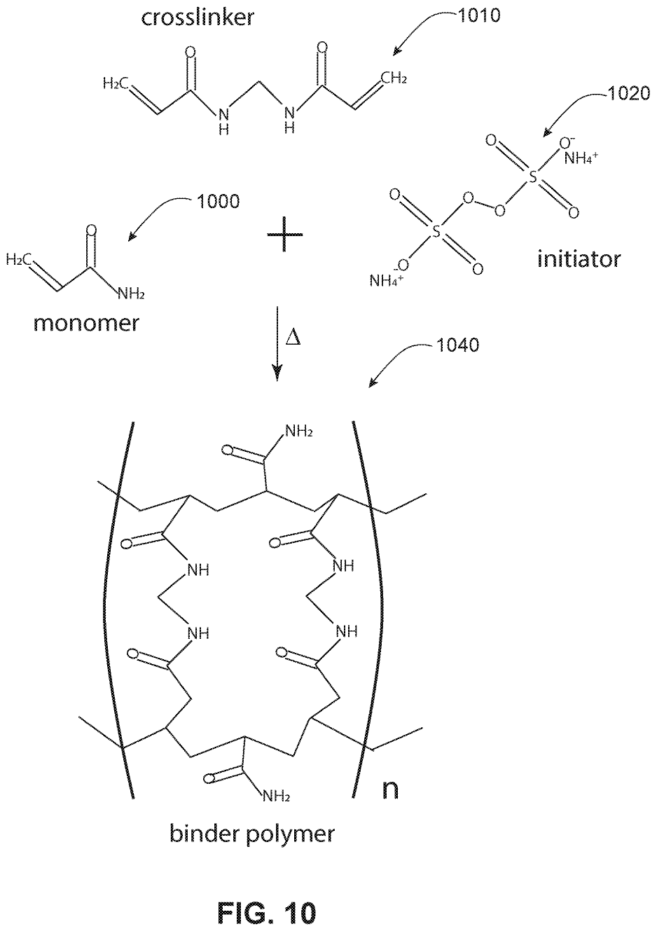

FIG. 10 illustrates molecular structures of acrylamide monomer 1000, N, N′ methylene bismethacrylamide crosslinker 1010, and ammonium persulfate initiator 1020 of the binder mixture, in accordance with at least one embodiment. A molecular structure 1040 of the resulting polymer is also shown.

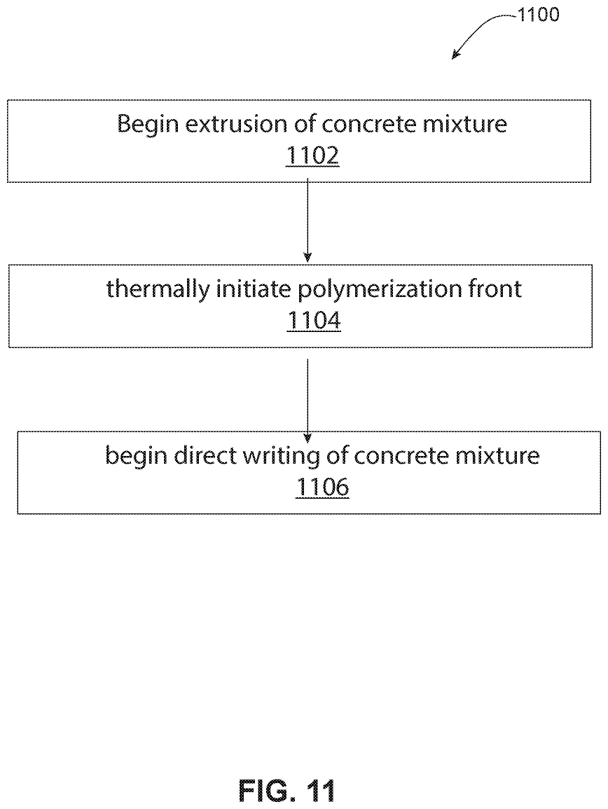

FIG. 11 illustrates a flowchart 1100 for an exemplary method for direct writing of the concrete mixture having a composition according to at least one embodiment.

At operation 1102, a print head as shown in FIG. 1A as print head 106, comprising a reservoir and a nozzle at the base of the reservoir (e.g., reservoir 102 and nozzle 104) is filled with a concrete composition according to at least one embodiment disclosed herein. For example, a composition may include a binder solution, or a clay, such as kaolinite, sand, or organic materials such as plant fibers (e.g., hemp, jute). In at least one embodiment, biochar is included as an organic material. Biochar is produced by burning plant materials. The foregoing ingredients may make up at least a portion of the dry content of the concrete mixture. In at least one embodiment, the binder solution includes an initiator compound, a monomer compound and a crosslinker compound dissolved in aqueous solution. In at least one embodiment, the initiator compound is ammonium persulfate; the monomer is acrylamide, and the crosslinker is methylenebisacrylamide. The solvent is water. In at least one embodiment, the composition of the concrete mixture comprises 11 wt % to 13 wt % binder, 67 wt % to 77 wt % dry content.

Within the reservoir, the concrete mixture is liquidous, having a suitable viscosity to enable extrusion but not too low of a viscosity to cause the extrudate to lose its shape. The extrusion may commence by increasing the pressure in the reservoir. An increase in pressure may be accomplished by a pump, depressing a plunger similar to a syringe plunger, or by an auger mechanism. When extrusion is started by pressing the concrete mixture through the nozzle attached to the reservoir, in some embodiments attached to the base of the reservoir, the extrudate begins to flow out of the nozzle, retaining an approximately similar cross-sectional shape of the nozzle.

At operation 1104, the polymerization front is initiated by addition of heat to the front of the extrudate. A flame from a torch may be employed, or a hot plate or rod may be employed, where the surface may be glowing. In at least one embodiment, the extrudate front is heated to over 200° C. for at least 10 seconds. The addition of heat injects the energy of activation to start the polymerization reaction by RICFP, as noted above. Due to the exothermicity of the polymerization reaction, the polymerization front is self-propagating. Thus, the polymerization front moves at a velocity down the extrudate in the direction of the nozzle. The composition of the concrete mixture may include sufficient initiator content to support polymerization.

At operation 1106, the print head is translated to perform a direct write operation, where an elongated extrudate is produced. In at least one embodiment, the speed of translation of the print head may match the velocity of the polymerization front. For example, the polymerization front may advance at a rate ranging between 2 and 7 cm/min. In at least one embodiment, the speed of translation of the print head may be matched to this rate of advance of the polymerization front. In at least one embodiment, the extrudate hardens rapidly upon polymerization to reach a compressive strength of at least 3 MPa within 30 seconds. The rapid setting up of the concrete mixture enables printing without sagging. Thus, the extrudate may be printed without the need for supports.

This compressive strength is sufficient to allow an extrudate to support the weight of multiple extrudates in a stack. In at least one embodiment, the direct write operation is enabled to print multiple extrudates in a stack, such as shown in FIGS. 9B and 9C. Within one day, the compressive strength of the extrudate reaches at least 15 MPa.

Here, some methods and devices may be shown in block diagram form, rather than in detail, to avoid obscuring present disclosure. Reference throughout this specification to “an implementation,” “one implementation,” or “some implementations” means that a particular feature, structure, function, or characteristic described in connection with an example is included in at least one example of disclosure. Thus, appearances of the phrase “in an implementation,” “in one implementation,” “in at least one implementation,” or “some implementations” in various places throughout this specification are not necessarily referring to same example of disclosure. Furthermore, particular features, structures, functions, or characteristics can be combined in any suitable manner in one or more examples. For example, a first example can be combined with a second example anywhere particular features, structures, functions, or characteristics associated with two examples are not mutually exclusive. A list of definitions follows, whereby following definitions may provide or augment literal support for claims.

As used herein, singular forms “a,” “an,” and “the” are intended to include plural forms as well, unless context clearly indicates otherwise. It will also be understood that the term “and/or” as used herein refers to and encompasses all possible combinations of one or more of associated listed items.

Here, “coupled” and “connected,” along with their derivatives, may be used to describe functional or structural relationships between components. These terms are not intended as synonyms for each other. Rather, in particular examples, “connected” may be used to indicate that two or more elements are in direct physical, optical, or electrical contact with each other. “Coupled” may be used to indicate that two or more elements are in either direct or indirect (with other intervening elements between them) physical, electrical, or magnetic contact with each other, and/or that two or more elements cooperate or interact with each other (e.g., as in a cause-and-effect relationship). “Coupled” may also include non-mechanical contact or connection. “Coupling” may also mean thermal connectivity, where one object may be a heat source and another object may be a heat sink, either in thermal equilibrium with each other or subject to a common conductive, convective, or radiative heat flow between them; electrical coupling, where objects may be connected electrically in an electric or electronic circuit and a current flow may be induced by application of a voltage between the electrically interconnected objects or by an electric field between mechanically coupled or isolated objects; magnetic coupling, where two mechanically coupled or isolated objects mutually share a common magnetic field flux; and fluidic coupling, where objects such as vessels and conduits may share a common gas or liquid fluid that is static or flowing.

Here, a device that is “configured to” perform a task or function may be configured (e.g., programmed and/or hardwired) at a time of manufacturing by a manufacturer to perform the function. In at least one example, the device may be configurable (or reconfigurable) by a user after manufacturing to perform the function and/or other additional or alternative functions. In at least one example, the configuring may be through firmware and/or software programming of the device, through a construction and/or layout of hardware components and interconnections of the device, or a combination thereof.

Here, “between” may be employed in context of z-axis, x-axis, or y-axis of a device. A material that is between two other materials may be in contact with one or both of those materials. In another example, a material that is between two or more materials may be separated from both of the other two materials by one or more intervening materials. A material “between” two other materials may therefore be in contact with either of the other two materials. In another example, a material “between” two other materials may be coupled to the other two materials through an intervening material. A device that is between two other devices may be directly connected to one or both of those devices. In another example, a device that is between two other devices may be separated from both of the other two devices by one or more intervening devices.

Here, “over,” “under,” “between,” and “on” can generally refer to a relative position of one component or material with respect to other components or materials where such physical relationships are noteworthy. Unless these terms are modified with “direct” or “directly,” one or more intervening components or materials can be present. Similar distinctions are to be made in context of component assemblies. As used throughout this description, and in claims, a list of items joined by term “at least one of” or “one or more of” can mean any combination of listed terms.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” the second material if device is oriented upside-down relative to context of figure provided. Similar distinctions are to be made in context of component assemblies.

Here, “adjacent” can generally refer to a position of a thing being next to (e.g., immediately next to or close to with one or more things between them) or adjoining another thing (e.g., abutting it).

Unless otherwise specified in explicit context of their use, terms “substantially equal,” “about equal,” and “approximately equal” can generally mean that there is no more than incidental variation between two things so described. In at least one example, such variation is no more than +/−10% of referred value.

In the following paragraphs, examples are provided that illustrate various examples. Examples can be combined with other examples. As such, various examples can be combined with other examples without changing scope of disclosure.

Example 1 is a concrete composition comprising a reinforcement material comprising a clay material; a sand material; a biochar material; a fiber material; and a binder, wherein a ratio of the binder to reinforcement material ranges between 1:7 to 2:7.

Example 2 is a concrete composition as in any of the examples, in particular example 1, wherein the clay material comprises any one of a bentonite clay, a kaolinite clay, a fire clay, a ball clay, or a lateritic clay.

Example 3 is a concrete composition as in any of the examples, in particular example 2, wherein the fiber material is a plant-based or a synthetic fiber.

Example 4 is a concrete composition as in any of the examples, in particular example 3, wherein the plant-based fiber material comprises any one of a jute fiber, a coir fiber, a bamboo fiber, a sisal fiber, or a hemp fiber.

Example 5 is a concrete composition as in any of the examples, in particular example 3, wherein the synthetic fiber comprises any one of a polyamide (e.g., Nylon) fiber, a polyester fiber, a polycarbonate fiber, a polypropylene fiber, a polyethylene fiber, a glass fiber, or alkali-resistant cellulose.

Example 6 is a concrete composition as in any of the examples, in particular example 1, wherein the binder is derived from a binder mixture, wherein the binder mixture includes a monomer compound.

Example 7 is a concrete composition as in any of the examples, in particular example 6, wherein the binder is derived from a binder mixture, wherein the monomer compound is acrylamide. Example 8 is a concrete composition as in any of the examples, in particular example 6, wherein the binder mixture includes a crosslinker compound.

Example 9 is a concrete composition as in any of the examples, in particular example 7, wherein the crosslinker compound is methylene bisacrylamide.

Example 10 is a concrete composition as in any of the examples, in particular example 6, wherein the binder mixture includes an initiator compound.

Example 11 is a concrete composition as in any of the examples, in particular example 10, wherein the initiator compound is ammonium persulfate.

Example 12 is a concrete composition as in any of the examples, in particular example 6, wherein the binder mixture comprises a monomer content of 15 wt % or less of the concrete composition, a crosslinker content ranging between 1 and 2 wt % of the concrete composition, and an initiator content is ranging between 2 and 14 wt % of the concrete composition.

Example 13 is a concrete composition as in any of the examples, in particular example 1, wherein a dry content of the concrete mixture ranges between 67 and 77 wt %, and wherein the dry content comprises the clay material, the sand material, the organic fiber material, the biochar, and a solid content of the binder mixture.

Example 14 is a concrete composition as in any of the examples, in particular example 1, wherein the binder comprises a cross-linked polymer comprising a polyamide backbone and cross-linking groups, and wherein the cross-linking groups comprise a primary amide group.

Example 15 is a method comprising: beginning an extrusion of a concrete mixture to create an extrudate, wherein the concrete mixture comprises a reinforcement material comprising a clay material; a sand material; a biochar material; a fiber material; and a binder, wherein a ratio of binder material wt % to reinforcement material wt % ranges between 1:7 to 2:7; initiating a polymerization front of the extrudate; and beginning direct writing of the extrudate.

Example 16 is a method as in any of the examples, in particular example 15, wherein beginning the extrusion of the concrete mixture to create the extrudate comprises pressurizing a reservoir containing the concrete mixture.

Example 17 is a method as in any of the examples, in particular example 16, wherein pressurizing the reservoir containing the concrete mixture comprises pressing the concrete mixture through a nozzle attached to the reservoir.

Example 18 is a method as in any of the examples, in particular example 15, wherein initiating a polymerization front of the extrudate comprises heating the front of the extrudate to a temperature of at least 200° C. for at least 10 seconds in one example.

Example 19 is a method as in any of the examples, in particular example 17, wherein beginning direct writing of the extrudate comprises translating a print head comprising the reservoir while pressing the concrete mixture out of the nozzle.

Example 20 is a method as in any of the examples, in particular example 19, wherein beginning direct writing of the extrudate comprises translating the print head comprising the reservoir at a rate substantially matching that of an advance speed of the polymerization front of the extrudate.

Example 21 is a method as in any of the examples, in particular example 20, wherein the print head is translated at rates between in some embodiments, the print head may be translated at rates between 2 cm/min to 10 cm/min.

Besides what is described herein, various modifications can be made to the disclosed examples and implementations thereof without departing from their scope. Therefore, illustrations of examples herein should be construed as examples, and not restrictive to scope of present disclosure.

What is claimed is:

1. A concrete composition, comprising:
a reinforcement material comprising:
a clay material;
a sand material;
a biochar material;
a fiber material; and
a polymer binder, wherein a ratio of the polymer binder to the reinforcement material ranges between 1:7 to weight ratio of the polymer binder to the reinforcement material ranges between 1:7 and 2:7.

2. The concrete composition of claim 1, wherein the clay material comprises any one of a bentonite clay, a kaolinite clay, a fire clay, a ball clay, or a lateritic clay.

3. The concrete composition of claim 2, wherein the fiber material is a plant-based fiber or a synthetic fiber.

4. The concrete composition of claim 3 wherein the plant-based fiber comprises any one of a jute fiber, a coir fiber, a bamboo fiber, a sisal fiber, or a hemp fiber.

5. The concrete composition of claim 3, wherein the synthetic fiber comprises any one of a polyamide (e.g., Nylon) fiber, a polyester fiber, a polycarbonate fiber, a polypropylene fiber, a polyethylene fiber, a glass fiber, or alkali-resistant cellulose.

6. The concrete composition of claim 1, wherein the polymer binder is derived from a binder mixture, wherein the binder mixture includes a monomer compound.

7. The concrete composition of claim 6, wherein the monomer compound is acrylamide.

8. The concrete composition of claim 6, wherein the binder mixture includes a crosslinker compound.

9. The concrete composition of claim 8, wherein the crosslinker compound is methylene bisacrylamide.

10. The concrete composition of claim 6, wherein the binder mixture includes an initiator compound.

11. The concrete composition of claim 10, wherein the initiator compound is ammonium persulfate.

12. The concrete composition of claim 6, wherein the binder mixture comprises a monomer content of 15 wt % or less of the concrete composition, a crosslinker content ranging between 1 and 2 wt % of the concrete composition, and an initiator content ranging between 2 and 14 wt % of the concrete composition.

13. The concrete composition of claim 1, wherein a dry content of the concrete composition ranges between 67 and 77 wt %.

14. The concrete composition of claim 1, wherein the polymer binder comprises a cross-linked polymer comprising a polyamide backbone and cross-linking groups, and wherein the cross-linking groups comprise a primary amide group.

15. A method, comprising:
extruding a concrete mixture to create an extrudate, wherein the concrete mixture comprises:
a reinforcement material comprising:
a clay material;
a sand material;
a biochar material;
a fiber material; and
a binder, wherein a ratio of the binder wt % to reinforcement material wt % ranges between 1:7 to 2:7;
initiating a polymerization front of the extrudate; and
beginning direct writing of the extrudate.

16. The method of claim 15, wherein extruding of the concrete mixture to create the extrudate comprises pressurizing a reservoir containing the concrete mixture.

17. The method of claim 16, wherein pressurizing the reservoir containing the concrete mixture comprises pressing the concrete mixture through a nozzle attached to the reservoir.

18. The method of claim 15, wherein initiating the polymerization front of the extrudate comprises heating the polymerization front of the extrudate to a temperature of at least 200° C. for at least 10 seconds.

19. The method of claim 17, wherein beginning the direct writing of the extrudate comprises translating a print head comprising the reservoir while pressing the concrete mixture out of the nozzle.

20. The method of claim 19, wherein beginning the direct writing of the extrudate comprises translating the print head comprising the reservoir at a rate matching that of equal to an translation speed of the polymerization front of the extrudate.

21. The method of claim 20, wherein the print head is translated at rates between 2 cm/min and 10 cm/min.
